(19) United States
(12) Patent Application Publication
(10) Pub. No.: US 2005/0160646 A1
(43) Pub. Date: Jul. 28, 2005

(54) Sign holder and system for signage

(76) Inventor: Robert Thomas DeSalle, Wallingford, CT (US)

Correspondence Address: LAW OFFICE OF MICHAEL A. BLAKE, 167 CHERRY STREET, NO. 405, MILFORD, CT, 06460, US

(21) Appl. No.: 10/939,626

(22) Filed: Sep. 13, 2004

Related U.S. Application Data
(60) Provisional application No. 60/539,085, filed on Jan. 26, 2004.

(51) Int. Cl. G09F 15/02; G09F 7/10

(52) U.S. Cl. 40/606.18

(57) ABSTRACT

A signage system comprising: a sign holder with a slot located along a length of the sign holder; a wall; and where the sign holder is attachable to a top surface of the wall.

### CROSS-REFERENCE TO RELATED APPLICATION

The present non-provisional application claims the benefit of U.S. provisional application Ser. No. 60/539,085, filed on Jan. 26, 2004.

### TECHNICAL FIELD

The present invention relates generally to signage, and more specifically to sign holders such as nameplates and other means of identification.

### BACKGROUND

It has been well known to provide a sign or nameplate suitable for placement on desks, tables, and other pieces of furniture. Many such signs or nameplates were supported on holders that were of expensive construction, but that still did not serve to display such sign in an attractive or easily viewable manner.

In recent years, the use of cubicles, instead of traditional offices, has achieved prominence in the business environment. However, the use of known signs and nameplates for identifying the location and identity of the person or thing located in a particular cubicle is problematic. For instance, when looking down an aisle-way formed by a plurality of cubicles, it is difficult to read signs or nameplates that are placed against a cubicle wall because that sign or nameplate may be about parallel to the line of sight down the aisle-way, or may not be visible at all from that point of view.

Thus a need for signs or nameplates that are easily readable in the modern cubicle environment has been identified that overcomes the above listed disadvantages.

### SUMMARY

The disclosed embodiments relates to a signage system comprising: a sign holder with a slot located along a length of the sign holder; a wall; and where the sign holder is attachable to a top surface of the wall.

Additionally, the disclosed embodiments relate to a sign holder that is attachable to a top surface of a wall. Where the sign holder comprises: a vertical face; a slot located within the vertical face; a base in communication with the vertical face; and where the base has a base width that is about equal to the width of the wall.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a perspective view of one embodiment of the disclosed sign holder;

FIG. 2 is a perspective view of another embodiment of the disclosed sign holder;

FIG. 3 is a perspective view of one embodiment of the disclosed signage system;

FIG. 4 is a perspective view of another embodiment of the disclosed signage system; and

FIG. 5 is a perspective view of another embodiment of the disclosed sign holder.

References in the detailed description correspond to like references in the figures unless otherwise indicated.

### DETAILED DESCRIPTION

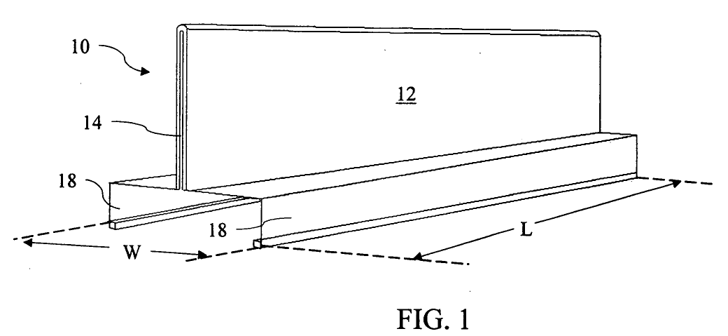

FIG. 1 shows one embodiment of the disclosed system for signage. A sign holder 10 is shown. The sign holder has a length “L” and a width “W”. The sign holder 10 has a vertical face 12 and a slot 14 running through the vertical face 12. The slot may be used to slide a sign into the sign holder 10. The slot 14 will run the length L of the sign holder.

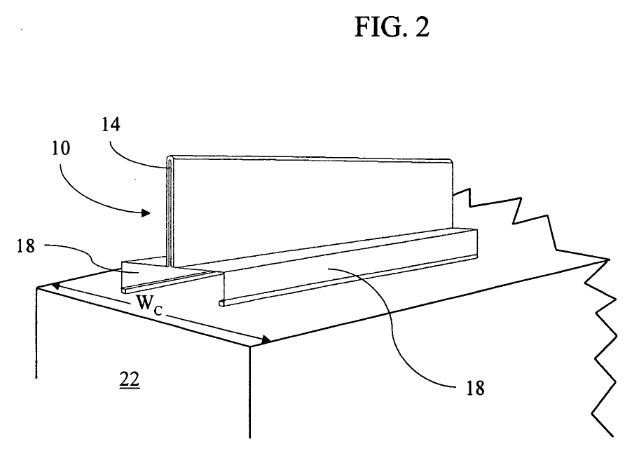

The base 18 of the sign holder 10 will have a width “W”. The dimension of W may vary depending on the use of the disclosed system. Referring to FIG. 2, in one embodiment the disclosed signage system is used to identify locations in an office cubicle environment. However, the signage system may be used in other environments such as, but not limited to indoor or outdoor warehouses, grocery store aisles, or any storage or housing facility. The dimension W may be equal to or less than the width of a cubicle wall 22, the width of the cubicle wall is designated by “W_{c}”. The base 18 of the sign holder 10 may be attached to the top of the cubicle wall 22 via a number of attachment methods, including, but not limited to: Velcro, hook and loop, magnet(s), adhesive, screws, snaps, double-sided tape, pins, brackets, clips, clamps, suction cups and buttons. Additionally, the sign holder may simply sit on a surface.

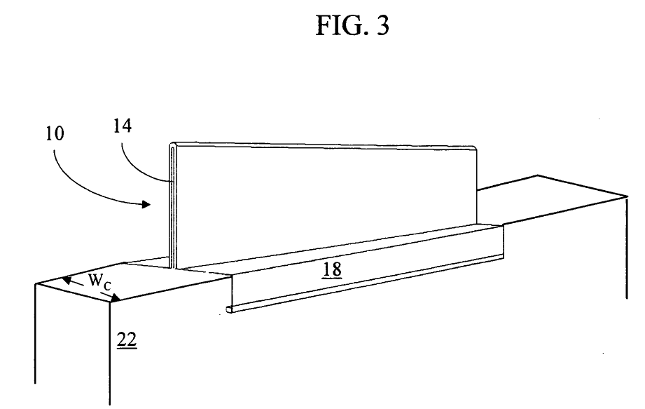

FIG. 3 shows another embodiment of the disclosed sign system. In this embodiment the sign holder 10 is slideable onto the cubicle wall 22 via the base 18. Thus, it should be noted that the base 18 may be made to accommodate different cubicle wall widths W_{c} and that W may be about slightly larger than W_{c}.

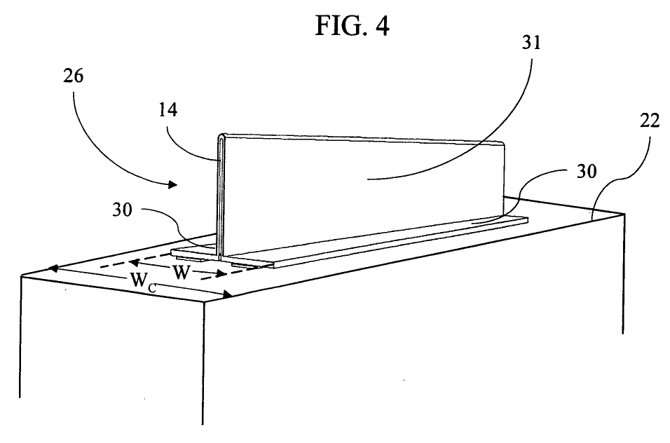

FIG. 4 shows yet another embodiment of the disclosed sign system. In this embodiment, a flat base sign holder 26 is shown attached to a cubicle wall 22. The flat base sign holder 26, has a flat base 30. The width of the flat base, “W”, may be equal to or less than the cubicle wall width, W_{c}. The flat base sign holder may be attached to the top of the cubicle wall 22 via a number of attachment methods, including, but not limited to: Velcro, hook and loop, magnet(s), adhesive, screws, snaps, double-sided tape, pins, brackets, clips, clamps, suction cups and buttons. Additionally, the sign holder may simply sit on a surface.

In another embodiment, the upper portion of the sign holder 26, may comprise an upper part 31 that is connectable to the base portion 30. The upper part 31 may be removably or permanently connectable to the base 30. The upper part 31 may be connectable to the base via a variety of means, including but not limited to: Velcro, hook and loop, magnet(s), adhesive, screws, snaps, double-sided tape, pins, brackets, clips, clamps, suction cups and buttons.

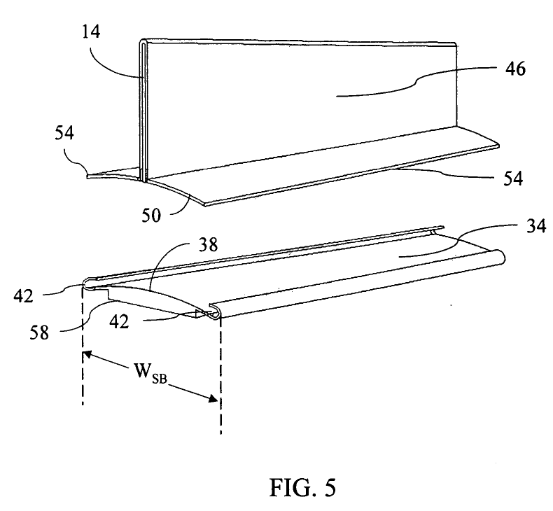

FIG. 5 shows another embodiment of the disclosed sign system. A separate sign holder base 34 is shown. The base 34 is shown with a upper surface 38. In this embodiment, the surface 38 is curved. However, in other embodiments, the surface 38 may be flat, or have a stepped cross-section, or any number of other cross-sectional shapes. Proximal to the surface 38 are two projecting edges, referred to as lips 42. An upper sign holder member 46 is slideable onto the base 34. The upper sign holder member may have a curved bottom surface 50 that allows it to fit flush against the curved surface 38. Alternatively, a flat base sign holder 26 may be used, so long as the flat base of the sign holder 26 is flexible enough to conform to the surface 38. In addition, if other cross-sectional shapes are used for the surface 38, the bottom surface 50 may have a complimentary shape such that a flush fit between surfaces 38 and 50 is provided. The lips 42 hold the edges 54 of the upper sign holder member to the base 34.

The separate sign holder base 34 has a width designated by W_{sb}. The width W_{sb} may be equal to or less than the width W_{c} of a cubicle wall. The sign holder base 34 has a lower surface 58 which may attach to a top of a cubicle wall 22 via a variety of methods, including, but not limited to: Velcro, hook and loop, magnet(s), adhesive, screws, snaps, double-sided tape, pins, brackets, clips, clamps, suction cups and buttons. Additionally, the sign holder may simply sit on a surface.

The various sign holders and bases discussed herein may be made from, but not limited to the following: clear acrylic; Lexan; polycarbonate; acrylic; plexiglass, PETG; various metals, wood, and plastics. Additionally, the sign holders and bases may be transparent, translucent, or any color or material desired by the end user. The materials used for the signage system may be non-glare. Additionally the thickness of the material may vary according to the needs of the end user.

Methods of fabricating the sign holder and/or base include, and are not limited to: molding; die-casting; extruding; and piece by piece heat form manufacturing.

Although the disclosed signage system has been discussed with respect to cubicle office systems, the signage system may be used for work stations; work spaces; frames; partitions; storage areas; and other situations where signage is helpful. Additionally the sign that is to be put into the slot 14, may be single sided, or double sided. Additionally, a variety of colors and materials may be used for the sign. The signage system may be configured to be distributed in a knock-down configuration, or may be knock-downable for storage.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims

1. A signage system comprising:
a sign holder with a slot located along a length of the sign holder;
a wall; and
wherein the sign holder is attachable to a top surface of the wall.

2. The signage system of claim 1, wherein the width of the sign holder is about equal to the width of the wall.

3. The signage system of claim 1, wherein the width of the sign holder is less than the width of the wall.

4. The signage system of claim 1, wherein the sign holder sits on the top surface of the wall.

5. The signage system of claim 1, wherein the sign holder slides onto the top of the wall.

6. The signage system of claim 1, wherein the sign holder is made from a material selected from the group consisting of clear acrylic, Lexan, polycarbonate, acrylic, Plexiglas, PETG, metal, and wood.

7. The signage system of claim 1, wherein the sign holder comprises:
an upper sign holder member;
a separate base, wherein the separate base comprises:
a first surface; and
at least one lip adjacent to the first surface.

8. The signage system of claim 7, wherein the upper sign holder member comprises a bottom surface that is configured to abut to the first surface.

9. The signage system of claim 8, wherein the first surface is a curved surface and the bottom surface is a curved surface.

10. The signage system of claim 1, wherein the sign holder is made from a see-through material.

11. The signage system of claim 1, wherein the sign holder is translucent.

12. A sign holder that is attachable to a top surface of a wall, the sign holder comprising:
a vertical face;
a slot located within the vertical face;
a base in communication with the vertical face; and
wherein the base has a base width that is about equal to the width of the wall.

13. The sign holder of claim 12, wherein the width of the base is less than the width of the wall.

14. The sign holder of claim 12, wherein the base attaches to a top surface of the wall.

15. The sign holder of claim 12, wherein the sign holder is made from a material selected from the group consisting of clear acrylic, Lexan, polycarbonate, acrylic, Plexiglas, PETG, metal, and wood.

16. The sign holder of claim 12, wherein the sign holder comprises:
an upper sign holder member;
a separate base; wherein the separate base comprises:
a first surface;
at least one lip adjacent to the first surface.

17. The sign holder of claim 16, wherein the upper sign holder member comprises a bottom surface that is configured to abut to the first surface.

18. The sign holder of claim 17, wherein the first surface is a curved surface, and the bottom surface is a curved surface.

19. The sign holder of claim 12, wherein the sign holder is made from a see through material.

20. The sign holder of claim 12, wherein the sign holder is translucent.
